(19) United States
(12) Patent Application Publication
(10) Pub. No.: US 2006/0255133 A1
(43) Pub. Date: Nov. 16, 2006

(54) COMMODITY MANAGING APPARATUS TO MANAGE COMMODITY, COMMODITY MANAGING METHOD, AND PROGRAM FOR MANAGING COMMODITIES

(75) Inventor: Tetsuya Takano, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: NEC INFRONTIA CORPORATION

(21) Appl. No.: 11/382,359

(22) Filed: May 9, 2006

(30) Foreign Application Priority Data
May 13, 2005 (JP) 2005-141112

(51) Int. Cl. G06K 15/00; G06Q 20/00

(52) U.S. Cl. 235/383; 705/16

(57) ABSTRACT

A generator acquires, from an index information storage unit, a group identifier and commodity identifiers stored in association with the group identifier. The generator also acquires commodity information associated with the commodity identifiers acquired from the index information storage unit, from an all PLU information storage units. The generator generates group-specific PLU information which associates the commodity identifiers acquired from the index information storage unit with the commodity information associated with the commodity identifiers and that is acquired from the all PLU information storage unit. A transmitter sends the group-specific PLU information generated by the generator to terminals belonging to a group that is identified by the group identifier corresponding to the group-specific PLU information.

### BACKGROUND OF THE INVENTION

1. Field of the Invention

The present invention relates to a commodity managing apparatus, a commodity managing method, and a program for managing commodities.

2. Description of the Related Art

POS (Point Of Sales) systems for managing all commodity information of commodities or goods sold at a plurality of shops have terminals installed in the respective shops. The terminals in the respective shops are connected to a main server through a network.

The main server generates commodity reference information (hereinafter referred to as PLU (Price Look Up) information) which associates commodity codes (e.g., JAN (Japanese Article Number) codes) identifying sold commodities or goods and commodity information such as sales prices, etc. of the commodities or goods identified by those commodity codes. The main server sends the generated PLU information to the terminals in the shops.

Each of the terminals includes a handy scanner or the like for reading commodity codes on commodities. The terminal acquires commodity information of a commodity based on the commodity code read from the commodity by the handy scanner and the PLU information. The POS system thus arranged makes it possible to manage the commodities in the shops efficiently.

The commodities that are placed for sale in the shops may differ from shop to shop. In such a case, if the main server sends the same PLU information to the terminals in the shops, then each of the terminals holds PLU information covering the merchandise which is not sold in the shop that is equipped with the terminal. Therefore, the terminals need to store a large amount of PLU information and hence they are expensive to manufacture. There is thus a demand for an efficient system for distributing PLU information to the terminals of the POS system.

JP-A No. 2001-93047, for example, discloses a POS system having a plurality of terminals installed in respective shops. The terminals are classified into a plurality of different groups, and each of the groups is associated with shops that handle the same commodities for sale. A PLU master file is prepared which associates commodity information of commodities for sale and group numbers identifying the groups with each other. The POS system employs the PLU master file and sends PLU files which contain different commodity information for the respective groups to the terminals belonging to the different groups.

With the disclosed POS system, one group number is associated with one commodity. For example, a terminal used in a bookstore and a terminal used in a stationery shop are classified into different groups. If the bookstore is to sell stationery after a PLU file has been generated for each of those groups, then the POS system is unable to handle a situation where the same commodity is sold by a plurality of shop groups.

### SUMMARY OF THE INVENTION

It is an object of the present invention to provide a commodity managing apparatus, a commodity managing method, and a program which are capable of efficiently distributing PLU information to terminals installed in respective different shops.

To achieve the above object, there is provided in accordance with the present invention a commodity managing apparatus for supplying terminals, installed respectively in a plurality of shops and classified into groups, with commodity information of commodities to be sold at the shops. The commodity managing apparatus has a shop information storage unit, a commodity information storage unit, an index information storage unit, a generator, and a transmitter.

The shop information storage unit stores terminal identifiers for identifying the terminals installed in each of in the shops, and stores the group identifiers associated with the terminal identifiers, that are used to identify the groups to which the terminals identified by the terminal identifiers belong.

The commodity information storage unit stores commodity identifiers for identifying the commodities and the commodity information, associated with the commodity identifiers, of the commodities identified by the commodity identifiers.

The index information storage unit stores the group identifiers and the commodity identifiers, associated with the group identifiers, for identifying the commodities to be sold at the shops in which the terminals belonging to the groups identified by the group identifiers are installed;

The generator acquires the commodity identifiers associated with the group identifiers from the index information storage, acquires the commodity information associated with the acquired commodity identifiers from the commodity information storage unit, and generates group-specific commodity reference information which associates the acquired commodity identifiers with the acquired commodity information; and

The transmitter sends the group-specific commodity reference information generated by the generator to the terminals which are identified by the terminal identifiers associated with the group identifiers which are associated with the commodity identifiers contained in the group-specific commodity reference information.

With the above arrangement, group-specific commodity reference information, which associates the commodity identifiers associated with the group identifier with the commodity information of commodities for sale, which are identified by the commodity identifiers, is generated for each group identifier. The group-specific commodity reference information that is generated for each group identifier is sent to the terminals identified by the terminal identifiers that are associated with the group identifier which is associated with the commodity identifiers contained in the group-specific commodity reference information in the index information storage unit.

Therefore, if the same commodity is to be sold in a plurality of groups, then it is possible to send group-specific commodity reference information to terminals belonging to those groups by associating the commodity identifier identifying the same commodity with the group identifiers that identify the groups. Therefore, commodity reference information (PLU information) can be distributed efficiently to the terminals installed in each of the shops.

The commodity managing apparatus should preferably further include a sales information storage unit, a manager, and a display unit.

The sales information storage unit stores the terminal identifiers, the commodity identifiers for identifying the commodities to be sold at the shops in which the terminals identified by the terminal identifiers are installed, and sales information of the commodities identified by the commodity identifiers, that are associated with the commodities to be sold.

The manager acquires the terminal identifiers associated with the group identifiers from the shop information storage unit, acquires the commodity identifiers and the sales information which are associated with the acquired terminal identifiers from the sales information storage unit, and generates group-specific sales information which associates the acquired commodity identifiers and the acquired sales information with each other; and

The display unit displays the group-specific sales information generated by the manager.

With the above arrangement, group-specific sales information, which associates commodity identifiers, associated with a group identifier, with the sales information of commodities for sale that are identified by the commodity identifiers, is generated for each group identifier. The sales for each group can thus be confirmed based on the group-specific sales information.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a block diagram of a commodity managing apparatus according to an embodiment of the present invention;

FIG. 2 is a diagram showing a shop database by way of example;

FIG. 3 is a diagram showing a PLU database by way of example;

FIG. 4 is a diagram showing an index database by way of example;

FIG. 5 is a diagram showing group-specific PLU information by way of example;

FIG. 6 is a diagram showing shop sales information by way of example; and

FIG. 7 is a flowchart of an operation sequence of the commodity managing apparatus;

FIG. 8 is a flowchart of an operation sequence of the commodity managing apparatus.

### DETAILED DESCRIPTION OF THE PREFERRED EMBODIMENT

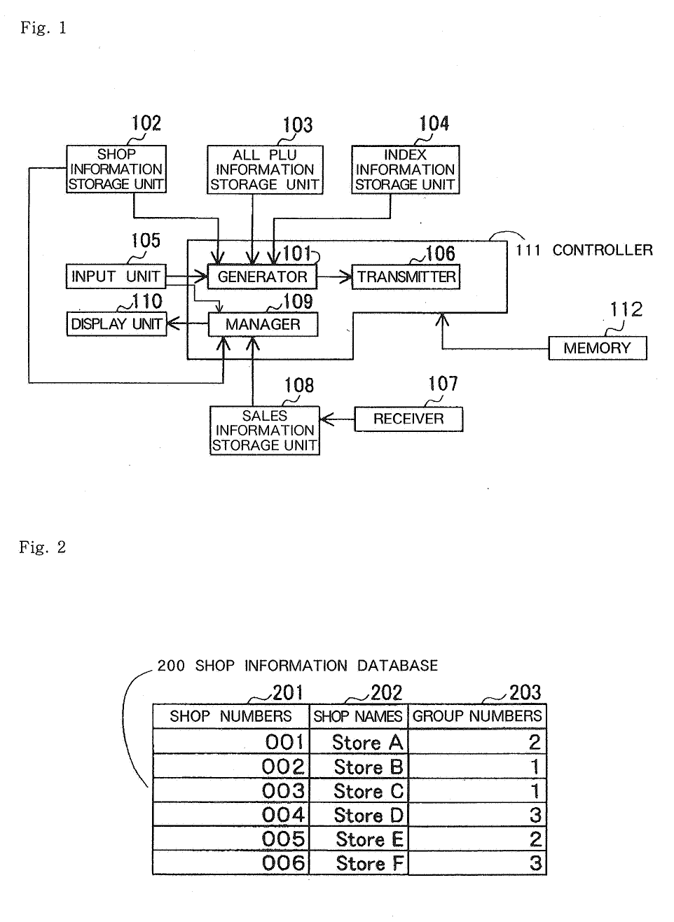

FIG. 1 shows in block form a commodity managing apparatus according to an embodiment of the present invention.

As shown in FIG. 1, the commodity managing apparatus comprises shop information storage unit 102, all PLU information storage unit 103, index information storage unit 104, input unit 105, receiver 107, sales information storage unit 108, display unit 110, controller 111, and memory 112.

Controller 111 includes generator 101, transmitter 106, and manager 109.

Memory 112 comprises a recording medium that can be read by a computer, and stores a program for controlling the operation of controller 111.

Controller 111 comprises a computer, for example. Controller 111 reads the program stored in memory 112 and executes the read program to implement generator 101, transmitter 106, and manager 109.

Shop information storage unit 102 stores a shop information database which associates terminal identifiers for identifying terminals installed in respective shops with group identifiers for specifying groups to which the terminals identified by the terminal identifiers belong.

FIG. 2 shows data of the shop information database by way of example. As shown in FIG. 2, shop information database 200 includes shop numbers 201, shop names 202, and group numbers 203.

Shop numbers 201 are numbers used to identify the terminals installed in the respective shops.

Shop names 202 are the names of the shops in which the terminals identified by shop numbers 201 are installed.

Group numbers 203 are numbers used to identify the groups to which the terminals identified by shop numbers 201 belong.

All PLU information storage unit 103 stores all PLU (Price Look Up) information. Specifically, all PLU information storage unit 103 stores a PLU database which associates commodity codes (e.g., JAN (Japanese Article Number) codes) identifying sold commodities or goods with commodity information of the commodities or goods identified by those commodity codes.

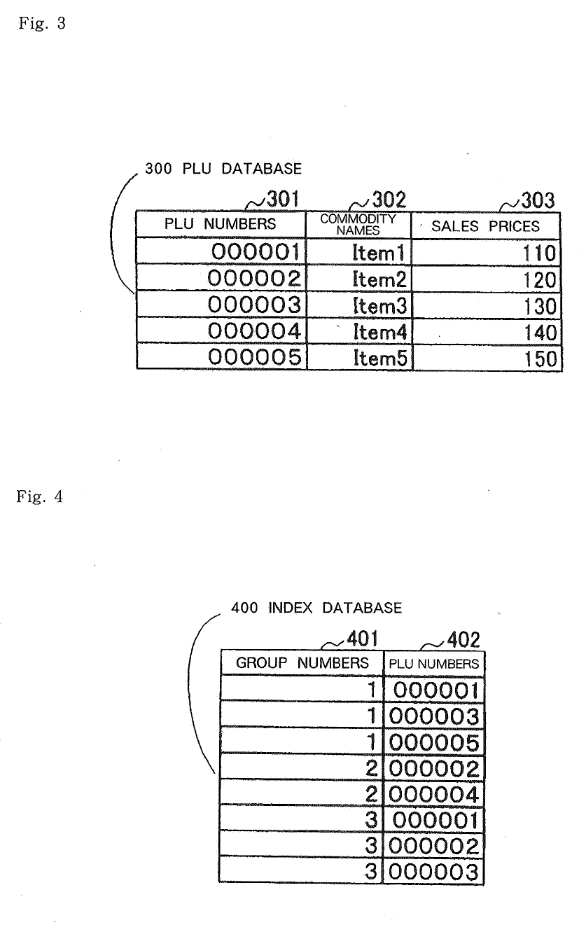

FIG. 3 shows data of the PLU database by way of example. As shown in FIG. 3, PLU database 300 includes PLU numbers 301, commodity names 302, and sales prices 303.

PLU numbers 301 are JAN code numbers, for example, and are used to identify commodities for sale.

Commodity names 302 are the names of commodities for sale that are identified by PLU numbers 301.

Sales prices 303 are the sales prices of commodities for sale that are identified by PLU numbers 301.

Index information storage unit 104 stores an index database which associates group identifiers with commodity identifiers for identifying commodities to be sold at shops in which the terminals belonging to the groups identified by the group identifiers are installed.

FIG. 4 shows data of the index database by way of example. As shown in FIG. 4, index database 400 includes group numbers 401 and PLU numbers 402.

Group numbers 401 are numbers for identifying groups to which the terminals installed in each of the respective shops belong.

PLU numbers 402 are JAN code numbers, for example, and are used to identify commodities to be sold at shops in which the terminals belonging to the groups identified by group identifiers 401 are installed.

Each of the group identifiers may be associated with a plurality of commodity identifiers. Each of the commodity identifiers may be associated with a plurality of group identifiers.

For example, as shown in FIG. 4, group number 401 “1” is associated with PLU number 402 “000001”, PLU number 402 “000003”, and PLU number 402 “000005”, and PLU number 402 “000001” is associated with group number 401 “1” and group number 401 “3”.

Input unit 105 comprises a keyboard, for example, and accepts inputs from the user.

When input unit 105 accepts generation request information for generating group-specific PLU information from the user, input unit 105 outputs the accepted generation request information to generator 101.

When generator 101 receives the generation request information from input unit 105, generator 101 acquires, from index information storage unit 104, a first group identifier and commodity identifiers stored in association with the first group identifier.

For example, when generator 101 receives the generation request information from input unit 105, generator 101 acquires, from index information storage unit 104, group number 401 “1” and PLU number 402 “000001”, PLU number 402 “000003”, and PLU number 402 “000005” which are stored in association with group number 401 “1”.

After generator 101 acquires the first group identifier and the commodity identifiers from index information storage unit 104, generator 101 acquires commodity information associated with the commodity identifiers acquired from index information storage unit 104, from all PLU information storage unit 103.

For example, after generator 101 acquires PLU number 402 “000001”, PLU number 402 “000003”, and PLU number 402 “000005” from index information storage unit 104, generator 101 acquires, from all PLU information storage unit 103, commodity name 302 “Item 1” and sales price 303 “110” 10 which are associated with PLU number 402 “000001”, commodity name 302 “Item 3” and sales price 303 “130” which are associated with PLU number 402 “000003”, and commodity name 302 “Item 5” and sales price 303 “150” which are associated with PLU number 402 “000005”.

Then, generator 101 generates first group-specific PLU information corresponding to the first group identifier, which associates the commodity identifiers acquired from index information storage unit 104 with the commodity information associated with the commodity identifiers and acquired from all PLU information storage unit 103.

FIG. 5 shows group-specific PLU information by way of example. As shown in FIG. 5, group-specific PLU information 500 includes PLU numbers 501, commodity names 502, and sales prices 503.

PLU numbers 501 are numbers for identifying commodities to be sold at shops in which the terminals belonging to the groups identified by the group identifiers are installed.

Commodity names 502 are the names of commodities for sale that are identified by PLU numbers 501.

Sales prices 503 are the sales prices of commodities for sale that are identified by PLU numbers 501.

After generator 101 generates the first group-specific PLU information, generator 101 acquires terminal identifiers associated with the first group identifier acquired from index information storage unit 104, from shop information storage unit 102, and outputs the acquired terminal identifiers in association with the generated first group-specific PLU information to transmitter 106.

After generator 101 outputs the terminal identifiers in association with the first group-specific PLU information to transmitter 106, generator 101 acquires a second group identifier and commodity identifiers stored in association with the second group identifier from index information storage unit 104.

After generator 101 acquires the second group identifier and the commodity identifiers stored in association with the second group identifier, generator 101 operates in the same manner as when it has generated the first group-specific PLU information to generate second group-specific PLU information corresponding to the second group identifier. Then, generator 101 associates the generated second group-specific PLU information with terminal identifiers which are acquired from shop information storage unit 102 and which are associated with the second group identifier acquired from index information storage unit 104, and outputs them to transmitter 106.

Generator 101 operates repeatedly in the manner described above to generate group-specific PLU information corresponding to all the group identifiers, associates the generated group-specific PLU information with terminal identifiers that are associated with group identifiers corresponding to the group-specific PLU information in shop information storage unit 102, and outputs them to transmitter 106.

Transmitter 106 accepts the group-specific PLU information and the terminal identifiers that are associated with each other from generator 101, and sends the accepted group-specific PLU information to the terminals identified by the accepted terminal identifiers according to the FTP (File Transfer Protocol), for example.

Receiver 107 accepts, from the terminals installed in each of the shops, shop sales information that associates a sales database, which associates commodity identifiers for identifying commodities to be sold in the shop where the terminal is installed with sales of the commodities identified by the commodity identifiers, with an identifier which identifies the terminal, and out-puts the accepted shop sales information to sales information storage unit 108.

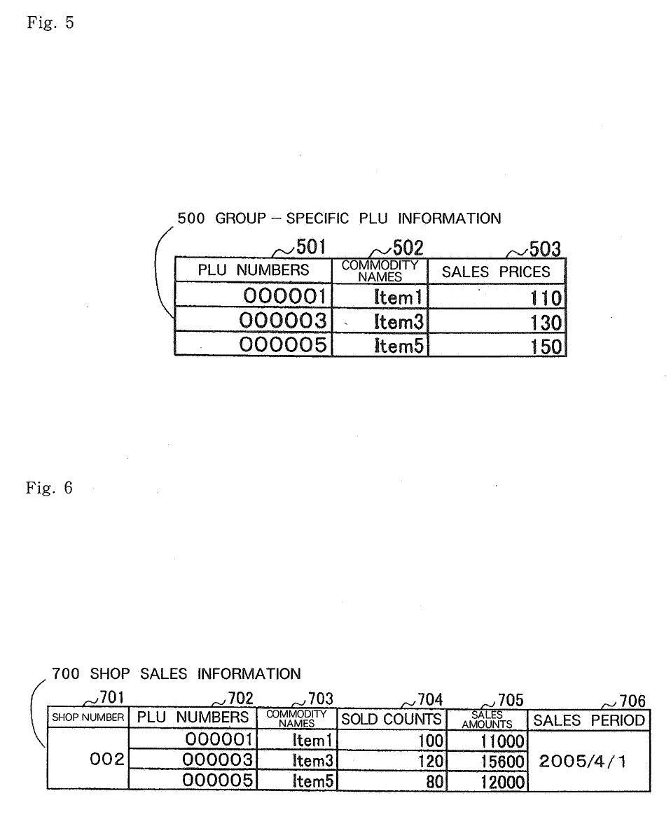

FIG. 6 shows shop sales information by way of example. As shown in FIG. 6, shop sales information 700 includes shop number 701, PLU numbers 702, commodity names 703, sold counts 704, sales amounts 705, and sales period 706.

Shop number 701 is a number used to identify the terminal installed in each shop.

PLU numbers 702 are numbers for identifying commodities to be sold at the shop in which the terminal identified by shop number 701 is installed.

Commodity names 703 are the names of commodities for sale that are identified by PLU numbers 702.

Sales counts 704 represent the numbers of commodities for sale that are identified by PLU numbers 702.

Sales amounts 705 represent the sales volumes of commodities for sale that are identified by PLU numbers 702.

Sales period 706 represents a date, for example, and is a period in which sales amounts 705 are calculated.

Sales information storage unit 108 accepts shop sales information from receiver 107, and stores the accepted shop sales information with respect to each of the terminal identifiers contained in the shop sales information.

When input unit 105 accepts a group sales display request for displaying the sales of each group from the user, input unit 105 outputs the accepted group sales display request to manager 109.

When manager 109 receives the group sales display request from input unit 105, manager 109 acquires, from shop information storage unit 102, a first group identifier (e.g., group number 203 “1”) and terminal identifiers (e.g., shop number 201 “002” and shop number 201 “003”) associated with the first group identifier.

Manager 109 acquires, from sales information storage unit 108, a sales database associated with the terminal identifiers acquired from shop information storage unit 102, and generates first group-specific sales information which associates the acquired sales database with the first group identifier acquired from shop information storage unit 102.

Manager 109 operates repeatedly in the manner described above to generate group-specific sales information corresponding to all the group identifiers, and outputs the generated group-specific sales information to display unit 110.

Display unit 110 comprises an information display device, for example.

Display unit 1 10 may display group-specific sales information according to any of various processes, e.g., a process for displaying sales amounts 705 in each sales period 706, which may be selected by the user.

Operation of the commodity managing apparatus will be described below.

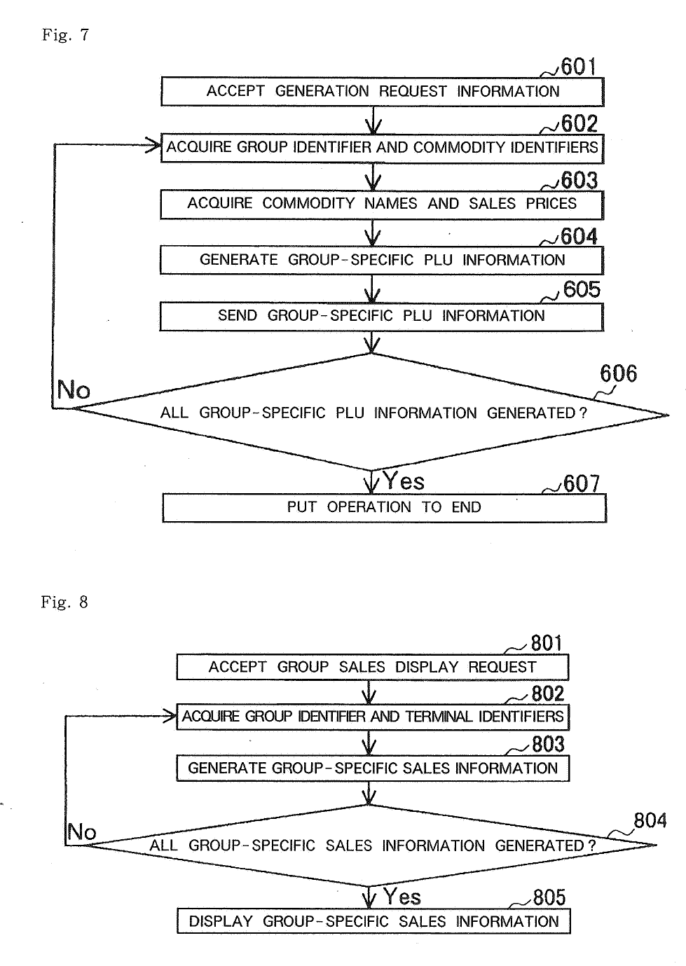

FIG. 7 is a flowchart of an operation sequence of the commodity managing apparatus according to the present embodiment. Specifically, in the illustrated operation sequence, the commodity managing apparatus generates group-specific PLU information, and sends the generated group-specific PLU information to the terminal installed in each shop.

In step 601 shown in FIG. 7, input unit 105 accepts generation request information for generating group-specific PLU information from the user, and outputs the accepted generation request information to generator 101.

Generator 101 receives the generation request information from input unit 105. Thereafter, control goes to step 602.

In step 602, generator 101 acquires, from index information storage unit 104, a certain group identifier and commodity identifiers stored in association with the group identifier. Then, control goes to step 603.

In step 603, generator 101 acquires commodity information associated with the commodity identifiers acquired from index information storage unit 104, from all PLU information storage unit 103. Then, control goes to step 604.

In step 604, generator 101 generates group-specific PLU information which associates the commodity identifiers acquired from index information storage unit 104 with the commodity information associated with the commodity identifiers and acquired from all PLU information storage unit 103. Then, control goes to step 605.

In step 605, generator 101 acquires terminal identifiers associated with the group identifier acquired from index information storage unit 104, from shop information storage unit 102, and outputs the acquired terminal identifiers in association with the generated group-specific PLU information to transmitter 106.

Transmitter 106 accepts the group-specific PLU information and the terminal identifiers that are associated with each other from generator 101, and sends the accepted group-specific PLU information to the terminals identified by the accepted terminal identifiers. Then, control goes to step 606.

In step 606, generator 101 determines whether group-specific PLU information corresponding to all the group identifiers has been generated or not. If it is judged that all the group-specific PLU information has been generated, then control goes to step 607. If it is judged that all the group-specific PLU information has not been generated, then control goes back to step 602.

In step 607, generator 101 concludes its operation.

FIG. 8 is a flowchart of an operation sequence of the commodity managing apparatus. Specifically, in the illustrated operation sequence, the commodity managing apparatus generates group-specific sales information, and displays the generated group-specific sales information.

In step 801 shown in FIG. 8, input unit 105 accepts a group sales display request for displaying the sales of each group from the user, and out-puts the accepted group sales display request to manager 109.

Manager 109 receives the group sales display request from in-put unit 105. Then, control goes to step 802.

In step 802, manager 109 acquires, from shop information storage unit 102, a certain group identifier and terminal identifiers associated with the group identifier. Then, control goes to step 803.

In step 803, manager 109 acquires, from sales information storage unit 108, a sales database associated with the terminal identifiers acquired from shop information storage unit 102, and generates group-specific sales information which associates the acquired sales database with the group identifier acquired from shop information storage unit 102. Then, control goes to step 804.

In step 804, manager 109 determines whether group-specific sales information corresponding to all the group identifiers has been generated or not. If it is judged that all the group-specific sales information has been generated, then control goes to step 805. If it is judged that all the group-specific sales information has not been generated, then control goes back to step 802.

In step 805, manager 109 outputs the group-specific sales information to display unit 110. Display unit 110 accepts the group-specific sales information and displays the accepted group-specific sales information.

According to the present embodiment, generator 101 acquires, from index information storage unit 104, a certain group identifier and commodity identifiers stored in association with the group identifier. Generator 101 acquires commodity information associated with the commodity identifiers acquired from index information storage unit 104, from all PLU information storage unit 103. Generator 101 generates group-specific PLU information corresponding to the group identifier, which associates the commodity identifiers acquired from index information storage unit 104 with the commodity information associated with the commodity identifiers and acquired from all PLU information storage unit 103.

Transmitter 106 sends the group-specific PLU information generated by generator 101 to the terminals belonging to the group that identify which corresponds to the group-specific PLU information.

In this manner, group-specific PLU information which associates the commodity identifiers associated with the group identifier with the commodity information of commodities for sale which are identified by the commodity identifiers is generated for each group identifier. The group-specific PLU information that is generated for each group identifier is sent to the terminals identified by the terminal identifiers that are associated with the group identifier corresponding to the group-specific PLU information.

Therefore, if the same commodity is to be sold in a plurality of groups, then it is possible to send group-specific PLU information to terminals belonging to those groups by associating the commodity identifier identifying the same commodity with the group identifiers identifying the groups. Therefore, PLU information can be distributed efficiently to the terminals installed in each of the shops.

According to the present embodiment, furthermore, manager 109 acquires, from shop information storage unit 102, a certain group identifier and terminal identifiers associated with the group identifier.

Manager 109 acquires, from sales information storage unit 108, a sales database associated with the terminal identifiers acquired from shop information storage unit 102, and generates group-specific sales information corresponding to the certain group identifier, which associates the acquired sales database with the group identifier acquired from shop information storage unit 102.

Display unit 110 displays the group-specific sales information generated by manager 109.

In this manner, group-specific sales information which associates commodity identifiers associated with a group identifier with the sales information of commodities for sale that are identified by the commodity identifiers is generated for each group identifier. The sales for each group can thus be confirmed based on the group-specific sales information.

While a preferred embodiment of the present invention has been described using specific terms, such description is for illustrative purposes only, and it is to be understood that changes and variations may be made without departing from the spirit or scope of the following claims.

What is claimed is:

1. A commodity managing apparatus for supplying terminals installed in each of a plurality of shops and classified into groups with commodity information of commodities to be sold at the shops, comprising:
a shop information storage unit for storing terminal identifiers for identifying the terminals installed in each of the shops and for storing group identifiers, associated with the terminal identifiers, in order to identify the groups to which the terminals in order to identify by said terminal identifiers belong;
a commodity information storage unit for storing commodity identifiers for identifying said commodities and for storing the commodity information, associated with the commodity identifiers, of the commodities identified by said commodity identifiers;
an index information storage unit for storing said group identifiers and said commodity identifiers, associated with said group identifiers, in order to identify said commodities to be sold at said shops in which the terminals belonging to the groups identified by the group identifiers are installed;
a generator for acquiring said commodity identifiers associated with said group identifiers from said index information storage, acquiring said commodity information associated with the acquired commodity identifiers from said commodity information storage unit, and generating group-specific commodity reference information which associates the acquired commodity identifiers with the acquired commodity information; and
a transmitter for sending said group-specific commodity reference information generated by said generator to said terminals which are identified by said terminal identifiers associated with said group identifiers which are associated with said commodity identifiers contained in said group-specific commodity reference information.

2. A commodity managing apparatus according to claim 1, further comprising:
a sales information storage unit for storing said terminal identifiers, said commodity identifiers for identifying said commodities to be sold at the shops in which the terminals identified by said terminal identifiers are installed, and sales information of said commodities identified by said commodity identifiers, that are associated with the commodities to be sold;
a manager for acquiring said terminal identifiers associated with said group identifiers from said shop information storage unit, acquiring said commodity identifiers and said sales information which are associated with the acquired terminal identifiers from said sales information storage unit, and generating group-specific sales information which associates the acquired commodity identifiers and the acquired sales information with each other; and
a display unit for displaying the group-specific sales information generated by said manager.

3. A method of managing commodities to be performed by a commodity managing apparatus for supplying terminals installed in each of a plurality of shops and classified into groups with commodity information of commodities to be sold at the shops, the commodity managing apparatus having a shop information storage unit for storing terminal identifiers to identify the terminals installed in each of the shops and for storing group identifiers, associated with the terminal identifiers, for identifying the groups to which the terminals identified by said terminal identifiers belong, a commodity information storage unit for storing commodity identifiers for identifying said commodities and the commodity information, associated with the commodity identifiers, of the commodities identified by said commodity identifiers, and an index information storage unit for storing said group identifiers and said commodity identifiers, associated with said group identifiers, for identifying said commodities to be sold at said shops in which the terminals belonging to the groups identified by the group identifiers are installed, said method comprising the steps of:
acquiring said commodity identifiers associated with said group identifiers from said index information storage, acquiring said commodity information associated with the acquired commodity identifiers from said commodity information storage unit, and generating group-specific commodity reference information which associates the acquired commodity identifiers with the acquired commodity information; and
sending said generated group-specific commodity reference information to said terminals which are identified by said terminal identifiers associated with said group identifiers which are associated with said commodity identifiers contained in said group-specific commodity reference information.

4. A method according to claim 3, wherein said commodity managing apparatus further has a sales information storage unit for storing said terminal identifiers, has said commodity identifiers for identifying said commodities to be sold at the shops in which the terminals identified by said terminal identifiers are installed, and has sales information of said commodities identified by said commodity identifiers, in association with each other, said method further comprising the steps of:
acquiring said terminal identifiers associated with said group identifiers from said shop information storage unit, acquiring said commodity identifiers and said sales information which are associated with the acquired terminal identifiers from said sales information storage unit, and generating group-specific sales information which associates the acquired commodity identifiers and the acquired sales information with each other; and
displaying the generated group-specific sales information.

5. A program for enabling a computer to perform a commodity managing process for supplying terminals installed respectively in a plurality of shops and classified into groups with commodity information of commodities to be sold at the shops, said computer being connected to a shop information storage unit for storing terminal identifiers for identifying the terminals installed respectively in the shops and group identifiers, associated with the terminal identifiers, for identifying the groups to which the terminals identified by said terminal identifiers belong, a commodity information storage unit for storing commodity identifiers for identifying said commodities and the commodity information, associated with the commodity identifiers, of the commodities identified by said commodity identifiers, and an index information storage unit for storing said group identifiers and said commodity identifiers, associated with said group identifiers, for identifying said commodities to be sole at said shops in which the terminals belonging to the groups identified by the group identifiers are installed, said commodity managing process comprising the steps of:
acquiring said commodity identifiers associated with said group identifiers from said index information storage, acquiring said commodity information associated with the acquired commodity identifiers from said commodity information storage unit, and generating group-specific commodity reference information which associates the acquired commodity identifiers with the acquired commodity information; and
sending said generated group-specific commodity reference information to said terminals which are identified by said terminal identifiers associated with said group identifiers which are associated with said commodity identifiers contained in said group-specific commodity reference information.

6. A program according to claim 5, wherein said computer is further connected to a sales information storage unit for storing said terminal identifiers, said commodity identifiers for identifying said commodities to be sold at the shops in which the terminals identified by said terminal identifiers are installed, and for identifying sales information of said commodities identified by said commodity identifiers, in association with each other, said commodity managing process further comprising the steps of:
acquiring said terminal identifiers associated with said group identifiers from said shop information storage unit, acquiring said commodity identifiers and said sales information which are associated with the acquired terminal identifiers from said sales information storage unit, and generating group-specific sales information which associates the acquired commodity identifiers and the acquired sales information with each other; and
displaying the generated group-specific sales information.
